(19) United States
(12) Patent Application Publication
(10) Pub. No.: US 2010/0304333 A1
(43) Pub. Date: Dec. 2, 2010

(54) EXPANDABLE DENTAL IMPLANT

(76) Inventor: Ali Babazadeh Ghavidel, Houston, TX (US)

Correspondence Address: WILLIAMS, MORGAN & AMERSON, 10333 RICHMOND, SUITE 1100, HOUSTON, TX, 77042, US

(21) Appl. No.: 12/476,781

(22) Filed: Jun. 2, 2009

(51) Int. Cl. A61C 8/00

(52) U.S. Cl. 433/173

(57) ABSTRACT

An expandable dental implant is provided. The dental implant comprises a crown portion, an expandable root and a cam. The expandable root portion has a plurality of members pivotally coupled to the crown portion. The cam is coupled to the crown portion and is slidably engageable with at least a portion of the plurality of members to urge the members to pivot outward and expand the root portion.

### BACKGROUND OF THE INVENTION

1. Field of the Invention

This invention relates generally to dental implants, and, more particularly, to a dental implant having an expandable root portion.

2. Description of the Related Art

Dental implants are well known in the art. Typically, a site in a patient's jaw bone is prepared for receiving the dental implant by drilling a borehole having a diameter substantially similar to the diameter of the dental implant. The dental implant is inserted into the borehole; however, the interconnection between the dental implant and the bone is generally inadequate to support an artificial tooth at that time. To enhance the anchoring of the dental implant within the patient's bone so that an artificial tooth can be adequately supported, it is common to wait for the dental implant to become more substantially anchored within the patient's bone. Over a period of four to six months, bone growth into and around the implant enhances the anchoring of the dental implant to the point of supporting an artificial tooth. At that time, the patient returns to the dentist/oral surgeon where an artificial tooth is secured to the implant. Unfortunately, during the intervening four to six months, the patient is without a tooth, which can lead to difficulties in chewing. Moreover, the missing tooth may be unattractive in appearance.

Further, typical dental implants face additional shortcomings with respect to their placement in a patient's upper jaw. As a patient ages, the sinus cavity enlarges as bone is lost, particularly in the floor of the sinus. This loss of bone reduces the thickness of the upper jaw bone where the dental implant will need to be placed. Typically, the upper jaw bone should have a thickness of about 10 mm to provide sufficient anchorage for a conventional dental implant. In cases where the upper jaw bone is too thin, it is common for an oral surgeon to first perform a sinus lift by placing a bone graft in the sinus cavity to increase the thickness of the upper jaw bone in the region of the implant. Typically, it will take about two to three months for the bone graft to become dense enough for a dental implant to be attempted. Thus, unfortunately, this procedure further exacerbates the time period over which the patient will be without a tooth. For example, the patient first visits the oral surgeon to have the sinus lift performed. Two to three months later, the patient again visits the oral surgeon to have dental implant surgery. Finally, four to six months later, the patient will visit the oral surgeon/dentist to have an artificial tooth affixed to the implant. Thus, the patient may be without a tooth in his upper jaw for about six to nine months. Having a missing tooth for such a protracted period of time may lead to additional problems, such as a shifting of teeth adjacent the site of the dental implant. Moreover, the additional surgery introduces substantial risks of complications, such as infections that further extend the time period before an artificial tooth may be placed on the implant.

### SUMMARY OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a dental implant is provided. The dental implant comprises a crown portion, an expandable root and a cam. The expandable root portion has a plurality of members pivotally coupled to the crown portion. The cam is coupled to the crown portion and is slidably engageable with at least a portion of the plurality of members to urge the members to pivot outward and expand the root portion.

In another embodiment, a dental implant is provided. The dental implant comprises a crown portion, an expandable root and a threaded member. The crown portion is configured to retain a dental restoration and has a longitudinally extending threaded channel. The expandable root portion comprises a plurality of members pivotally coupled to the crown portion. The threaded member is positioned in the longitudinally extending threaded channel and has a crown end and a root end. The crown end is configured to receive a tool for turning and activating the threaded member. The root end is configured to engage the plurality of members and urge the members outward when the threaded member is activated.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 illustrates a perspective view of a first embodiment of a dental implant according to the principles of the instant invention;

FIGS. 2A and 2B respectively illustrate a front elevation and a cross sectional view of one embodiment of the dental implant in a non-actuated or pre-installed position is shown;

FIGS. 2C and 2D respectively illustrate a side elevation and a cross sectional view of one embodiment of the dental implant in a non-actuated or pre-installed position;

FIG. 3 illustrates a side elevation of one embodiment of the dental implant in an actuated or installed position;

FIGS. 4A-4D respectively illustrate a perspective, top, side and front views of one embodiment of the crown portion of the dental implant.

FIGS. 5A-5D respectively illustrate a perspective, side, back and top views of one embodiment of one member of the root portion of the dental implant;

FIG. 6 illustrates an exploded perspective view of one embodiment of a dental implant; and

FIGS. 7A-7B, respectively illustrate upper and lower perspective views of one embodiment a dental implant.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

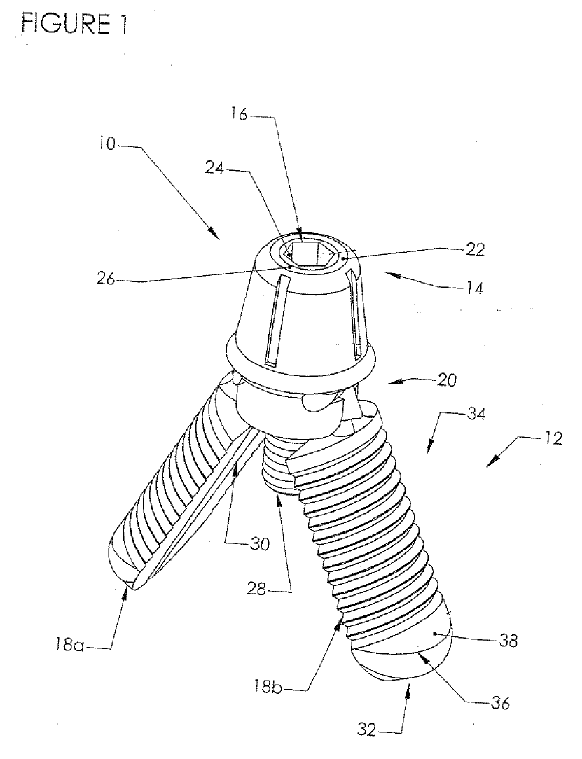

FIG. 1 illustrates a perspective view of a first exemplary embodiment of the instant invention. Generally, a dental implant 10 is comprised of an expandable root portion 12, a crown portion 14, and an actuating member 16. In the illustrated embodiment, the expandable root portion 12 is comprised of two members 18a, 18b that are pivotally coupled at a first end portion 20 to the crown portion 14 and are generally free for pivotal movement relative to the crown portion 14.

The crown member 14 includes an elongated central bore 22 with at least a portion of the bore being threaded to receive the actuating member 16. The actuating member 16 is likewise threaded for engagement with the threaded portion of the bore 22. The actuating member 16 includes a tool engaging surface 24 at a first end portion 26 thereof. In the illustrated embodiment, the tool engaging surface 24 takes the form of a hexagonal opening adapted to receive a tool, such as a hex key or allen wrench, therein. Those skilled in the art will readily appreciate that other tool engaging surfaces may be employed, such as, surfaces that mate with a flat blade screwdriver, a phillips screwdriver, a starhead screwdriver, a socket, a wrench, etc. The oral surgeon/dentist may use the tool to rotate the actuating member 22 in a clockwise direction, causing the actuating member 16 to be displaced longitudinally within the bore 22 in a direction toward the root portion 12.

A second end portion 28 of the actuating member 16 may contact an inner surface 30 of one or more of the members 18a, 18b to urge the members to pivot relative to the crown portion 14. Longitudinal movement of the actuating member 16 toward the members 18a, 18b causes the second end portion 28 of the actuating member 16 to contact the inner surface 30 of the members 18a, 18b applying a force against the inner surface 30. Because the first end portion 20 of the members 18a, 18b is pivotally coupled to the crown portion 14 while a second end portion 32 of the members 18a, 18b are free to move relative to the crown 14, the members 18a, 18b pivot outwardly, urging the second end portions 32 of the members 18a, 18b into substantial contact with the bore walls (not shown) formed in the jaw bone of the patient.

Outer surfaces 34 of the members 18a, 18b may be formed with an irregular surface to enhance frictional contact between the jaw of the patient and the dental implant 10. This enhanced frictional contact contributes to the immediate anchoring of the dental implant 10 such that an artificial tooth may be substantially immediately placed on the crown portion 14 of the dental implant 10 during the same office visit. The irregular outer surface 34 of the members 18a, 18b may take any of a variety of forms. For example, the second end portion or apical portion 32 may have a convex region with one or more ridges 36 and grooves 38 formed thereon.

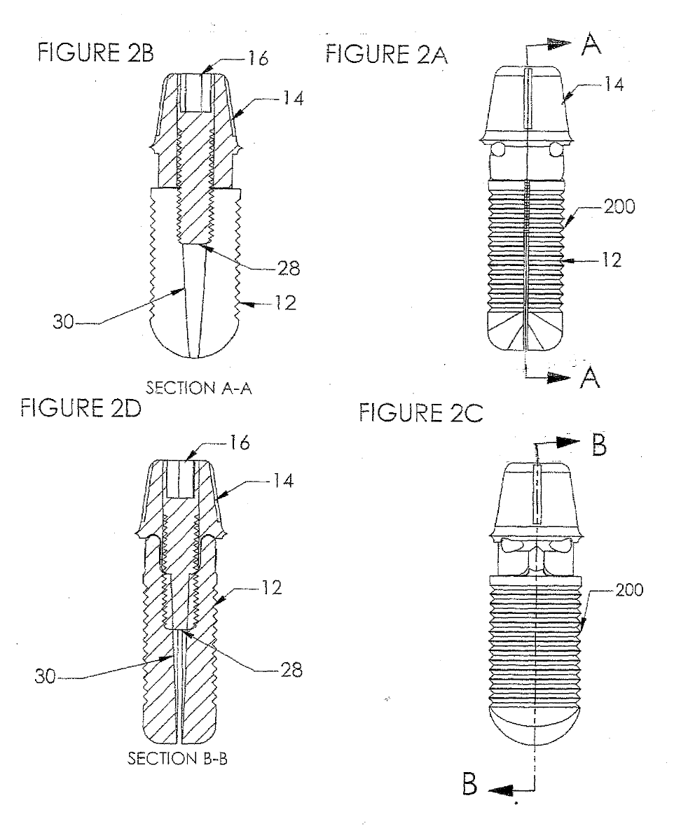

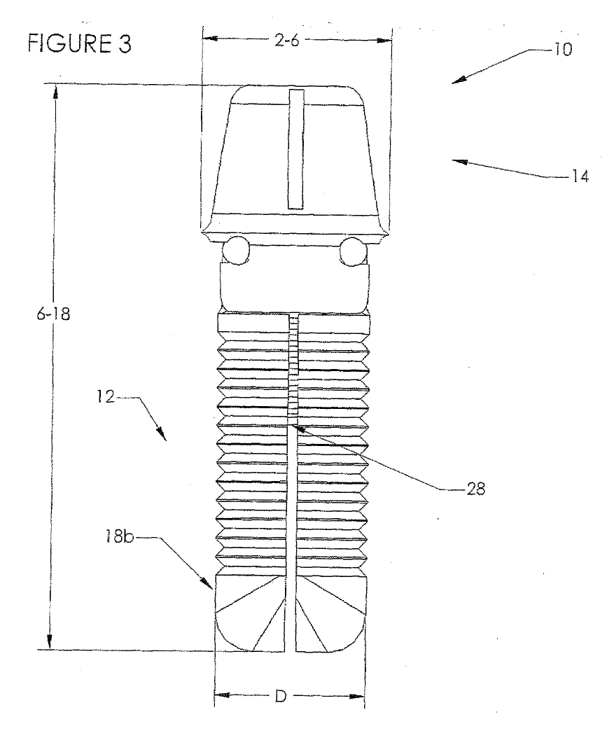

Turning now to FIGS. 2A and 2B, a front elevation and a cross sectional view of the dental implant 10 in a non-actuated or pre-installed position is shown. Additionally, FIGS. 2C and 2D, illustrate a side elevation and a cross sectional view of the dental implant 10 in a non-actuated or pre-installed position. As can be seen, the members 18a, 18b include an intermediate portion 200 that has been threaded to allow the non-actuated dental implant 10 to be inserted into the jaw bone of a patient using a screwing action. Alternatively, the borehole formed in the patient's jaw bone may be substantially similar to the outer diameter of the dental implant 10 so that the implant may be slid or tapped into place in the borehole. The presence of the threads on the outer surface 34 will nevertheless enhance the irregularity of the outer surface 34 such that bone growth into the threads may further enhance anchoring of the dental implant in the patient's jaw bone.

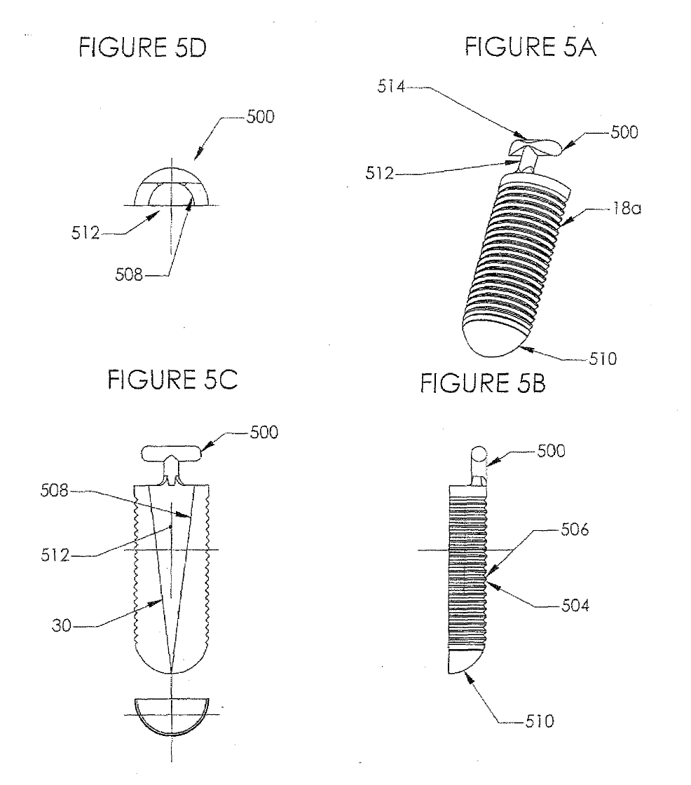

In the illustrated embodiment, as seen in the top view of FIG. 4B (discussed more fully below), the cross sectional configuration of the dental implant 10 is substantially circular, with the members 18a, 18b being substantially semi-circular in cross section. After the dental implant 10 has been initially placed into the jaw bone of the patient to a desired height, the actuating member 16 may be used to expand the members 18a, 18b to more substantially engage the inner bore hole formed in the patient's jaw bone to more fully anchor the dental implant 10.

The structure and operation of the actuating member 16 may be more fully appreciated in the cross sectional views of FIGS. 2B and 2D. In particular, the configuration of the inner surface 30 of the members 18a, 18b is inclined relative to the longitudinal axis of the actuating member 16. That is, as the actuating member 16 is turned clockwise, the threaded portions of the crown portion 14 and actuating member 16 move the actuating member 16 longitudinally toward the root portion 12. As the actuating member 16 moves in this direction, it contacts the inclined inner surfaces 30 of the members 18a, 18b and urges the members 18a, 18b to pivot outwardly. The inclined inner surfaces 30 act as a cam surface slidably engaging the actuating member 16. In the illustrated embodiment, the further the actuating member 16 moves longitudinally, the greater the members 18a, 18b are pivoted outward. It is envisioned that greater or lesser pivotal movement may be achieved, as desired, by varying the angle of inclination of the inner surfaces 30.

Those skilled in the art will appreciate that the surface of the actuating member 16 could also be constructed to have an inclined surface thereon to also act as a cam surface relative to the inner surface 30 to produce a desired pivotal movement of the members 18a, 18b. In this embodiment of the instant invention, the inner surface may have a smaller angle of inclination, or even no inclination, relying instead on the inclined surface of the actuating member 16 to produce the pivotal movement of the members 18a, 18b.

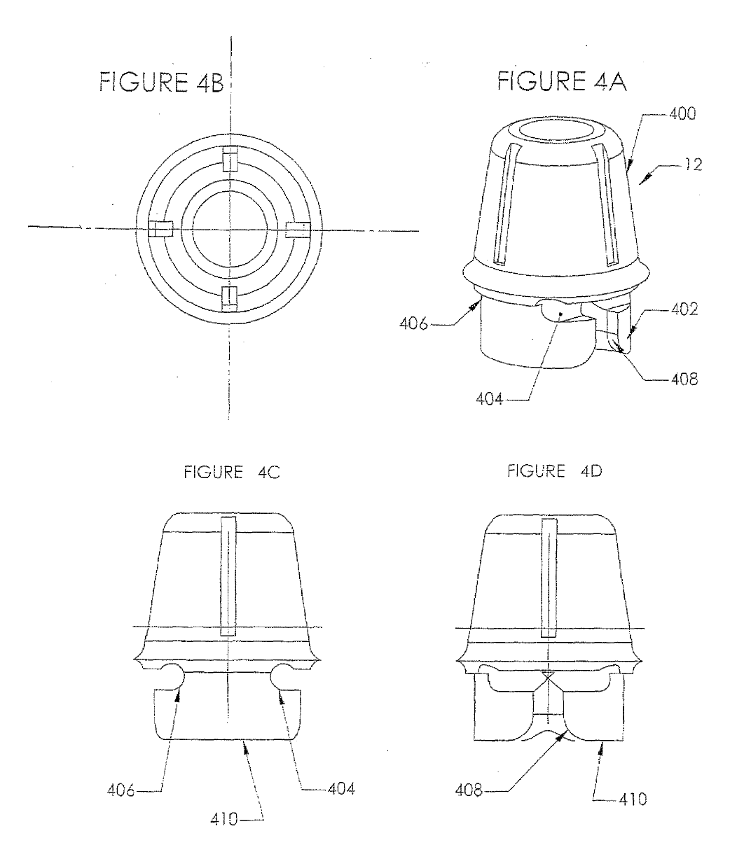

FIG. 3 shows a front elevation of the dental implant 10 in an actuated or installed position. In the illustrated embodiment, the actuating member 16 has been screwed into the dental implant 10 to displace the first end portion 28 longitudinally toward the root portion 12. The first end portion 28 has contacted the cam surface of the members 18a, 18b and urged them outwardly so that the apical end of the root portion 12 has an increased diameter D.

FIGS. 4A-4D respectively illustrate a perspective, top, side and front views of one embodiment of the crown portion 14 of the dental implant 10. The crown portion 12 is comprised of a frustoconically shaped upper portion 400 and a cylindrical low portion 402. The upper portion 400 is configured to receive an artificial tooth thereon, as is conventional in the art.

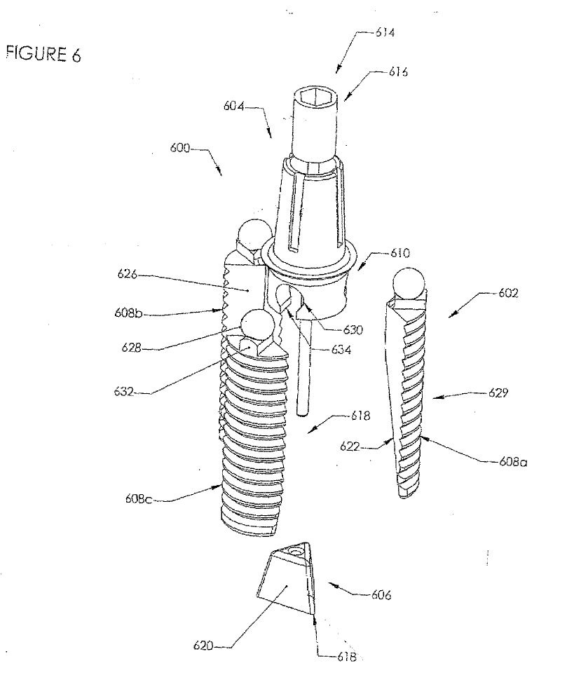

Transverse slots 404, 406 are formed on opposite sides of the crown portion 12 and are adapted to receive a retaining and pivoting mechanism 500 on the members 18a, 18b (discussed more fully in conjunction with FIG. 5 below). Opposing longitudinal slots 408 intersect the transverse slots 404, 406 at about their midpoint and extend toward the root portion 12 while opening on a bottom surface 410 of the crown portion 12.

FIGS. 5A-5D respectively illustrate a perspective, side, back and top views of one embodiment of one member 18a of the root portion 12 of the dental implant 10. The member 18a is comprised of a T-shaped retaining and pivoting mechanism 500 attached to a semi-cylindrical body 502. The outer surface of the semi-cylindrical body 502 includes a plurality of ridges 504 and grooves 506 that interact with the inner wall of the borehole in the patient's jaw to aid in retaining the dental implant 10. Retention may be enhanced by urging the ridges 504 into the bone of the patient's jaw, and also by the growth of the patient's bone into the grooves 506 over time.

The inner surface 30 of the member 18a includes a groove 508 extending generally longitudinally and varying in depth along the longitudinal axis. The groove 508 is deepest adjacent the T-shaped retaining and pivoting mechanism 500 and becomes shallower in a direction extending along the longitudinal axis 512 toward an apical end portion 510 of the member 18a. The varying depth groove 508 forms the inclined cam surface of the member 18a that effects pivotal movement of the member 18a in response to contact with and longitudinal movement of the actuating member 16.

The T-shaped retaining and pivoting mechanism 500 includes a longitudinal bar 512 and a transverse bar 514 formed into a substantially T-shape extending from the semi-cylindrical body 502. Assembly of the member 18a to the crown portion 14 involves positioning the longitudinal axis of the member 18a at about 90° relative to the longitudinal axis of the crown portion 14. In this position, the transverse bar 514 is aligned with the groove 404 and passed therein until the longitudinal bar 512 aligns with the longitudinal groove 408. At this point, the member 18a is pivoted to insert the longitudinal bar 512 into the longitudinal groove 408 thereby capturing the member 18a against further transverse movement relative to the crown portion 14 while still permitting pivotal movement of the member 18a relative to the crown portion 14.

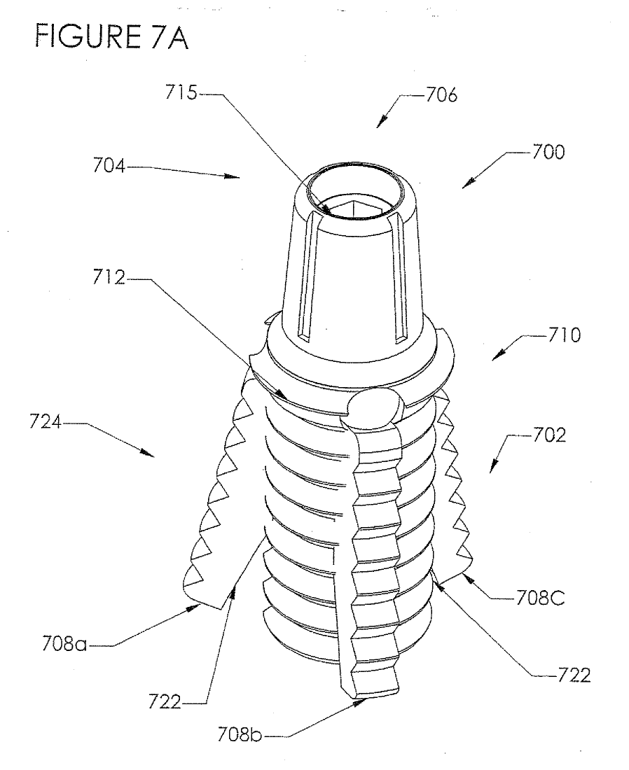

Turning now to FIG. 6, an alternative embodiment of the instant invention is illustrated. An exploded, perspective view of a dental implant 600 is shown. Generally, the dental implant 600 is comprised of an expandable root portion 602, a crown portion 604, and an actuating member 606. In the illustrated embodiment, the expandable root portion 602 is comprised of three members 608a, 608b, 608c that are pivotally coupled at a first end portion 610 to the crown portion 604 and are generally free for pivotal movement relative to the crown portion 604.

The crown member 604 includes an elongated central bore (not shown) with at least a portion of the bore being threaded to receive the actuating member 606. The actuating member 606 is likewise threaded for engagement with the threaded portion of the bore. The actuating member 606 includes a tool engaging surface 614 at a first end portion 616 thereof. In the illustrated embodiment, the tool engaging surface 604 takes the form of a hexagonal opening adapted to receive a tool, such as an allen wrench, therein. The oral surgeon/dentist may use the tool to rotate the actuating member 606 in a clockwise direction, causing the actuating member 606 to be displaced longitudinally within the bore in a direction toward the crown portion 14.

A second end portion 618 of the actuating member 606 includes a cam 620 coupled thereto. In the illustrated embodiment, the cam 618 includes three inclined surfaces 620 that contact a rear surface 622 of the members 608a, 608b, 608c may contact an inner surface 622 of one or more of the members 608a, 608b, 608c to urge the members to pivot relative to the crown portion 604. Longitudinal movement of the cam 618 toward the crown portion 604 causes the second cam 618 to contact the inner surface 622 of the members 608a, 608b, 608c, applying a force against the inner surface 622. Because the first end portion of the members 608a, 608b, 608c is pivotally coupled to the crown portion 604 while a second end portion of the members 608a, 608b, 608c are free to move relative to the crown 604, the members 608a, 608b, 608c pivot outwardly, urging the second end portions of the members 608a, 608b, 608c into substantial contact with the bore walls (not shown) formed in the jaw bone of the patient.

Outer surfaces 624 of the members 608a, 608b, 608c may be formed with an irregular surface to enhance frictional contact between the jaw of the patient and the dental implant 600. This enhanced frictional contact contributes to the immediate anchoring of the dental implant 600 such that an artificial tooth may be substantially immediately placed on the crown portion 604 of the dental implant 10 during the same office visit. The irregular outer surface 624 of the members 608a, 608b, 608c may take any of a variety of forms. For example, the outer surfaces 624 may have a convex region with one or more ridges 36 and grooves 38 formed thereon.

Pivotal movement of the members 608a, 608b, 608c relative to the crown portion 604 may be accomplished by a variety of structures. For example, in the embodiment illustrated in FIG. 6, pivotal movement is accomplished by a ball and socket arrangement 626. A ball 628 is formed on the members 608a, 608b, 608c. A corresponding socket 630 is formed in the crown 604. The members 608a, 608b, 608c are assembled to the crown 604 by sliding the ball 628 radially into a corresponding socket 630 in the crown 604. Additionally, a key 632 is formed on the members 608a, 608b, 608c below the ball 628. A corresponding key way 634 is formed in the crown 604. The key 632 and corresponding key way 634 interact to limit the pivoting movement of the members 608a, 608b, 608c to substantially a single plane.

Those skilled in the art will appreciate that the angles of inclination of the surface of the cam 618 and the inner surface 622 of the members 608a, 608b, 608c could be varied to produce differing degrees of pivotal movement of the members 608a, 608b, 608c. In this embodiment of the instant invention, the inner surface 622 may have a smaller angle of inclination, or even no inclination, relying instead on the inclined surface of the actuating member 606 to produce the pivotal movement of the members 608a, 608b, 608c.

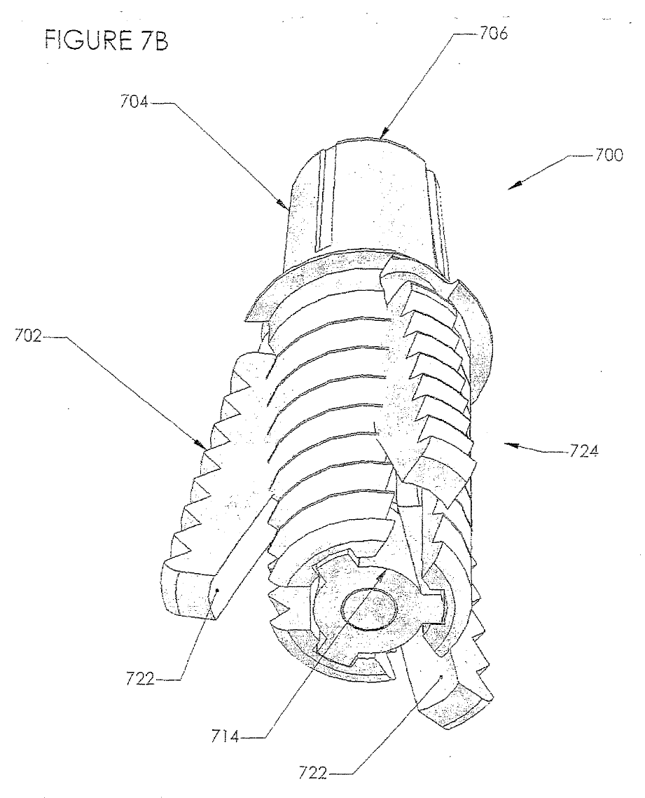

Turning now to FIGS. 7A and 7B, an alternative embodiment of the instant invention is illustrated. Upper and lower perspective views of a dental implant 700 are shown. Generally, the dental implant 700 is comprised of an expandable root portion 702, a crown portion 704, and an actuating member 706. In the illustrated embodiment, the expandable root portion 602 is comprised of three pivotal members 708a, 708b, 708c that are pivotally coupled at a first end portion 710 to a stationary portion 712 of the root portion 704 and are generally free for pivotal movement relative to the crown portion 704 and the stationary portion 712 of the root portion 704.

The crown member 704 includes an elongated central bore (not shown) and sized to receive the actuating member 706. The actuating member 706 is at least partial threaded for engaging a cam 714. The actuating member 706 includes a tool engaging surface 715 at a first end portion 616 thereof. In the illustrated embodiment, the tool engaging surface 715 takes the form of a hexagonal opening adapted to receive a tool, such as an allen wrench, therein. The oral surgeon/dentist may use the tool to rotate the actuating member 706 in a clockwise direction, causing the cam 714 to be displaced longitudinally upward within the bore in a direction away from the root portion 12.

In the illustrated embodiment, the cam 618 includes three inclined surfaces that contact a rear surface 722 of the members 708a, 708b, 708c to urge the members to pivot relative to the crown portion 704 and the stationary portion 712 of the root portion 704. Longitudinal movement of the cam 714 toward the crown portion 704 causes the cam 714 to contact the inner surface 722 of the members 708a, 708b, 708c, applying a force against the inner surface 722. Because the first end portion 710 of the members 708a, 708b, 708c is pivotally coupled to the stationary portion 712 of the root portion 702 while a second end portion of the members 708a, 708b, 708c are free to move relative to the crown 604 and stationary portion 712, the members 708a, 708b, 708c pivot outwardly, as shown in FIGS. 7A and 7B, urging the second end portions of the members 708a, 708b, 708c into substantial contact with the bore walls (not shown) formed in the jaw bone of the patient.

Outer surfaces 724 of the members 708a, 708b, 708c may be formed with an irregular surface to enhance frictional contact between the jaw of the patient and the dental implant 700. This enhanced frictional contact contributes to the immediate anchoring of the dental implant 700 such that a artificial tooth may be substantially immediately placed on the crown portion 704 of the dental implant 10 during the same office visit. The irregular outer surface 724 of the members 708a, 708b, 708c may take any of a variety of forms. For example, the outer surfaces 724 may have a convex region with one or more ridges 36 and grooves 38 formed thereon.

Pivotal movement of the members 708a, 708b, 708c relative to the crown portion 704 and fixed portion 712 may be accomplished by a variety of structures. For example, a ball and socket arrangement substantially similar to the ball and socket arrangement 626 shown and discussed above in conjunction with FIG. 6 above may be employed. In the embodiment shown in FIGS. 7A and 7B, a separate key and key way may not be needed because the stationary member 712 will operate to restrict movement of the members 708a, 708b, 708c to substantially a single plane.

Those skilled in the art will appreciate that the angles of inclination of the surface of the cam 714 and the inner surface 722 of the members 708a, 708b, 708c could be varied to produce differing degrees of pivotal movement of the members 708a, 708b, 708c. In this embodiment of the instant invention, the inner surface 722 may have a smaller angle of inclination, or even no inclination, relying instead on the inclined surface of the cam 714 to produce the pivotal movement of the members 708a, 708b, 708c.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A dental implant comprising:
a crown portion;
an expandable root portion having a plurality of members pivotally coupled to said crown portion; and
a cam coupled to said crown portion and being slidably engageable with at least a portion of the plurality of members to urge said members to pivot outward and expand the root portion.

2. A dental implant, as set forth in claim 1, further comprising said cam having a tool engaging surface for urging said cam to slidably engage at least a portion of the plurality of members.

3. A dental implant, as set forth in claim 1, further comprising said crown portion having a threaded opening formed therein, and said cam having a threaded member engaged with the threaded opening of said crown portion, said cam being rotatably operable to engage a cam surface with at least a portion of the pivotal members.

4. A dental implant, as set forth in claim 3, further comprising said threaded member having a tool engaging surface for rotating said cam.

5. A dental implant, as set forth in claim 1, further comprising at least one of the plurality of members having an apical portion having a convex region with ridges formed thereon.

6. A dental implant, as set forth in claim 1, further comprising at least a portion of said pivotal members having an irregular outer surface.

7. A dental implant, as set forth in claim 6, further comprising the irregular outer surface having at least one groove formed thereon.

8. A dental implant, as set forth in claim 6, further comprising the irregular outer surface having at least one ridge formed thereon.

9. A dental implant, as set forth in claim 6, further comprising at least one of the plurality of members having an apical portion having a convex region with ridges formed thereon.

10. A dental implant, as set forth in claim 1, further comprising said cam surface having an inclined plane.

11. A dental implant, as set forth in claim 1, further comprising at least one of the pivotal members having an inclined plane engageable with the cam surface.

12. A dental implant, as set forth in claim 1, further comprising said crown portion having a rotatable threaded member, and said cam having a threaded opening formed therein and engaged with the threaded member of said crown portion, said threaded member being rotatably operable to engage a cam surface with at least a portion of the pivotal members.

13. A dental implant, as set forth in claim 12, further comprising said cam surface having an inclined plane.

14. A dental implant, as set forth in claim 12, further comprising at least one of the pivotal members having an inclined plane engageable with the cam surface.

15. A dental implant, as set forth in claim 12, further comprising said threaded member having a tool engaging surface for rotating said cam.

16. A dental implant, as set forth in claim 12, further comprising at least one of the plurality of members having an apical portion having a convex region with ridges formed thereon.

17. A dental implant, as set forth in claim 12, further comprising at least a portion of said pivotal members having an irregular outer surface.

18. A dental implant, as set forth in claim 17, further comprising the irregular outer surface having at least one groove formed thereon.

19. A dental implant, as set forth in claim 17, further comprising the irregular outer surface having at least one ridge formed thereon.

20. A dental implant, as set forth in claim 17, further comprising at least one of the plurality of members having an apical portion having a convex region with ridges formed thereon.

21. A dental implant comprising:
a crown portion being configured to retain a dental restoration and having a longitudinally extending threaded channel;
an expandable root portion comprising a plurality of members pivotally coupled to said crown portion; and
a threaded member positioned in said longitudinally extending threaded channel and having a crown end and a root end, said crown end being configured to receive a tool for turning and activating said threaded member and said root end being configured to engage said plurality of members and urge said members outward when said threaded member is activated.

22. A dental implant, as set forth in claim 21, further comprising at least one of the plurality of members having an apical portion having a convex region with ridges formed thereon.

23. A dental implant, as set forth in claim 21, further comprising at least a portion of said pivotal members having an irregular outer surface.

24. A dental implant, as set forth in claim 23, further comprising the irregular outer surface having at least one groove formed thereon.

25. A dental implant, as set forth in claim 23, further comprising the irregular outer surface having at least one ridge formed thereon.

26. A dental implant, as set forth in claim 23, further comprising at least one of the plurality of members having an apical portion having a convex region with ridges formed thereon.

27. A dental implant comprising:
a crown portion configured for retaining a dental restoration and having a longitudinally extending threaded channel;
an expandable root portion comprising a plurality of members pivotally coupled to said crown portion;
a threaded member positioned in said longitudinally extending threaded channel and having a crown end and a root end, said threaded member being configured on said crown end to receive, and be activated by, a tool; and
a cam threadably engaged on the root end of said threaded member, said spreading member being positioned between said plurality of members and configured so that when said threaded member is activated, said spreading member is drawn toward said crown portion and forcing said plurality of members outward.

28. A dental implant, as set forth in claim 27, further comprising at least one of the plurality of members having an apical portion having a convex region with ridges formed thereon.

29. A dental implant, as set forth in claim 27, further comprising at least a portion of said pivotal members having an irregular outer surface.

30. A dental implant, as set forth in claim 29, further comprising the irregular outer surface having at least one groove formed thereon.

31. A dental implant, as set forth in claim 29, further comprising the irregular outer surface having at least one ridge formed thereon.

32. A dental implant, as set forth in claim 29, further comprising at least one of the plurality of members having an apical portion having a convex region with ridges formed thereon.
